(19) United States
(12) Patent Application Publication
(10) Pub. No.: US 2026/0205788 A1
(43) Pub. Date: Jul. 16, 2026

(54) SHARING OF WIRELESS COMMUNICATION LINKS AMONG CARAVAN OF MOTOR VEHICLES

(71) Applicant: FORD GLOBAL TECHNOLOGIES, LLC, DEARBORN, MI (US)

(72) Inventors: Brendan F. Diamond, Naples, FL (US); Keith Weston, Canton, MI (US); John R. Van Wiemeersch, Novi, MI (US); Chris M. Paiva, Novi, MI (US); Stuart C. Salter, White Lake, MI (US); Thomas J. Hermann, Troy, MI (US)

(21) Appl. No.: 19/023,721

(22) Filed: Jan. 16, 2025

(51) Int. Cl. H04W 4/90; H04W 4/12; H04W 76/50

(52) U.S. Cl. CPC H04W 4/90; H04W 4/12; H04W 76/50

(57) ABSTRACT

Emergency communication is provided between a vehicle and a public safety answering point (PSAP). The vehicle has a wireless peer-to-peer (P2P) transceiver exchanging two-way messages with remote transceivers in remote vehicles, a telematics unit for a mobile telephone system, and an emergency call activator. Polling messages are exchanged with the remote vehicles via the P2P transceiver. A group list of specific remote vehicles contactable via the P2P transceiver is compiled together with connection status of remote vehicles to the mobile telephone system. When the emergency call activator is triggered and the telematics unit is unable to intercommunicate with the mobile telephone system, then a remote vehicle is selected from the group list which has a respective connection to the mobile telephone system. A messaging sequence via the P2P transceivers relays an emergency call to the PSAP via the selected remote vehicle.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to two-way radio installations in motor vehicles, and, more specifically, to novel approaches for controlling and utilizing two-way radios to share access to cellular services among a group or caravan of vehicles.

Wireless telecommunications systems such as cellular telephone networks are relied on heavily by users for requesting emergency assistance while traveling. Calls made to emergency responders via a public safety answering point or PSAP (e.g., a 911 response center) may be explicitly dialed by a vehicle occupant or automatically initiated by a vehicle's electronic systems as a result of a trigger event (e.g., deployment of a safety system such as an air bag). Although cellular networks provide large coverage areas, there remains to be remote and/or topographically difficult areas where cellular service is absent or unreliable. Recreational usage of certain motor vehicles (e.g., off-road driving) may often involve traveling to areas without cellular connectivity (i.e., non-connected zones) such as mountains, deserts, or wilderness. Even in populated areas, a vehicle may be operated in an environment where wireless signals from cellular networks may be impeded (e.g., while in a tunnel or when blocked by nearby objects such as buildings and parking structures). Under these conditions, calls to a PSAP may fail.

Two-way wireless radio communication systems using shared channels in allocated radio spectrum are also popular with many users and have many important functions. In addition to non-licensed citizens band (CB) radios and walkie-talkies, there are licensed radio services such as public safety (e.g., police, fire, and medical) systems, industrial/business systems, and the General Mobile Radio Service (GMRS). These two-way radio systems are decentralized in order to enable two radio units to exchange audio and/or encoded data signals directly between them. Accordingly, these systems are referred to herein as wireless peer-to-peer (P2P) transceivers. Since vehicle manufacturers do not offer voice-capable two-way P2P transceivers as optional equipment in a vehicle, vehicle owners wanting a two-way radio transceiver attached to their vehicle will typically obtain it as an aftermarket installation.

Vehicle-to-vehicle (V2V) communications are used to share data wirelessly between vehicles operating nearby using wireless P2P transceivers according to radio technology for Dedicated Short Range Communications (DSRC). Typically, vehicles may form a wireless LAN on an ad hoc basis, and the vehicles may broadcast data to the WLAN when certain events are detected. The types of shared data have included details about obstacles in a roadway and the trajectories of surrounding vehicles to enable other approaching vehicles and improve safety.

A transceiver for a two-way radio capable of voice transmission is typically half duplex, wherein the transceiver operates by default in a receive mode until the user activates a transmit mode by continuously pressing a push-to-talk (PTT) switch. Operation of a two-way transceiver may be integrated with the vehicle in order to utilize vehicle components such as a microphone, speakers, and/or a touchscreen control panel. The transceiver can be wirelessly linked with vehicle components using Bluetooth®, Wi-Fi, or other wireless communication or can be linked by wire.

When a user in a vehicle wishes to establish contact with a PSAP during a time when they are in an area where the cellular service is unavailable, they may instead reach out to others via a two-way transceiver in the hopes that someone may be nearby who can help or in the hopes the other party is in a location that allows them acceptable cellular reception. Such an ad hoc approach to obtaining assistance is inefficient and may cause delay or may be unsuccessful. It would be desirable to improve the ability to access a PSAP whenever cellular service is unavailable.

### SUMMARY OF THE INVENTION

In one aspect of the invention, a vehicle adapted to communicate with a public safety answering point (PSAP) comprises a wireless peer-to-peer (P2P) transceiver adapted to exchange two-way messages with remote transceivers in remote vehicles and a telematics unit adapted to intercommunicate with a mobile telephone system. An emergency call activator is triggered in the vehicle according to predetermined emergency conditions in the vehicle. A logic controller is coupled to the wireless P2P transceiver and configured for exchanging polling messages with the remote vehicles, and for compiling a group list of specific remote vehicles which remain contactable via the wireless P2P transceiver together with a respective status of a connection of each remote vehicle to the mobile telephone system. When the emergency call activator is triggered and the telematics unit is unable to intercommunicate with the mobile telephone system, then the logic controller selects a remote vehicle from the group list which has a respective connection to the mobile telephone system and initiates a messaging sequence via the wireless P2P transceiver for relaying an emergency call to the PSAP via the selected remote vehicle.

### BRIEF DESCRIPTION OF THE DRAWINGS

FIG. 1 is a schematic diagram illustrating vehicles operating inside and outside a region of coverage of a cellular base station.

FIG. 2 is a schematic diagram showing two-way transceivers operable between a pair of vehicles.

FIG. 3 is a schematic diagram showing a group or platoon of vehicles operating in geographic proximity and within range of two-way peer-to-peer transceivers.

FIG. 4 depicts a group of vehicles within communication range of their two-way transceivers, with at least some vehicles also being within range of a cellular service.

FIG. 5 is a block diagram showing a vehicle capable of cellular and two-way P2P wireless communication.

FIG. 6 depicts a database within a vehicle for managing its communication with a group of vehicles.

FIG. 7 is a flowchart showing a method of the invention for managing a group.

FIG. 8 is a flowchart a method of the invention for initiating wireless messaging to a PSAP in an emergency situation via another vehicle within a group.

### DETAILED DESCRIPTION OF PREFERRED EMBODIMENTS

In some embodiments, two-way (peer-to-peer) radio-based messaging conducted in a group setting may include automated messages to manage a group (i.e., caravan of vehicles), to share information regarding the status of vehicles, and to request relaying of requests for assistance via a vehicle in contact with a mobile telephone service on behalf of a vehicle needing assistance which is not in contact with the mobile telephone service. When all other vehicles in contact with a host vehicle are likewise without cellular connectivity, the other vehicles might still act as potential good Samaritan candidates to come help. In some embodiments, a host vehicle may record the message transmissions and receptions as a deterrence to malicious use of an emergency call.

Vehicle status may be shared periodically (e.g., at regular time intervals or miles of travel) and/or immediately upon identifying vehicle error states such as an overheated engine, decreasing tire pressure, or the vehicle being stuck or immovable. Messages can include absolute and/or relative locations of a transmitting vehicle or other vehicles in a group (e.g., Vehicle A is at GPS coordinates x, y, z; or Vehicle A is one mile ahead of Vehicle B). Vehicle status can further include data such as fuel level, diagnostic trouble codes (DTCs) indicating vehicle malfunctions, and the number and/or condition of vehicle occupants, passengers, or other relevant parties in the group. In some embodiments, messages are human generated (i.e., not automatic). Spoken audio communication from one vehicle can be heard and acted upon in another vehicle, or can be automatically interpreted by the remote receiving vehicle using a speech recognition unit to display the interpreted speech on a display screen. When messages are sent using V2V communication, the data can be in any desired format (such as text, audio, video, or numeric). A host vehicle can use exterior and/or interior sensors or other components (e.g., GPS receiver, tire pressure sensors, cameras, microphones, etc.) to collect message content. Some messages may be auto-generated using Artificial Intelligence, Machine Learning, and/or Large Language Models for sharing with remote vehicles, as needed.

A primary method of P2P communication between vehicles is through voice broadcasting with a two-way radio that is controllable by the vehicle. In the absence of such a two-way radio, V2V can be used to provide the relevant messages regarding each vehicle status, DTCs, status of passengers, and the like. V2V communication can also be used to determine which vehicle(s) in the caravan can act as a relay to the mobile telephone system.

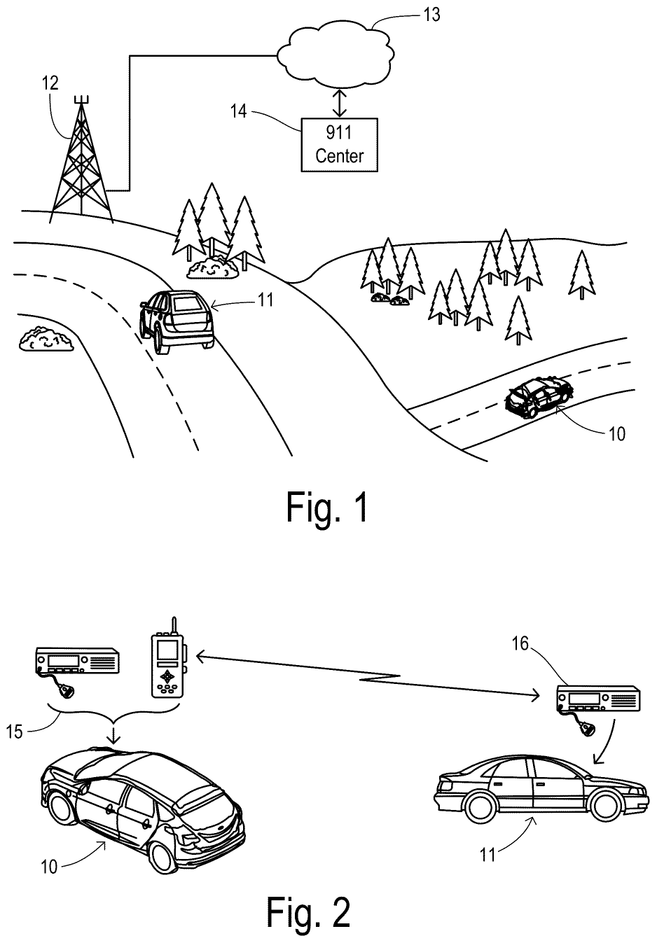

FIG. 1 depicts a situation where vehicles 10 and 11 are driving on respective roadways in a mountainous area. A cellular base station 12 is coupled to a network 13 in a mobile telephone system. A 911-center (i.e., PSAP) 14 is coupled to network 13 enabling customers of the mobile telephone system to make calls to center 14 to request assistance. Each vehicle 10 and 11 carries one or more mobile devices interoperative with the mobile telephone system. The mobile devices may include personal mobile phones of the vehicle occupants or may include cellular transceivers permanently installed in the vehicles. Due to the terrain or the relative distances, a cellular device in vehicle 11 is within range of base station 12 so that mobile telephone calls can be made, while a cellular device in vehicle 10 is out of range of base station 12 so that calls cannot be made. On the other hand, vehicles 10 and 11 may be situated such that wireless P2P transceivers in the vehicles are within their operating range so that peer-to-peer messages can be exchanged. As shown in FIG. 2, vehicle 10 carries a voice-capable two-way transceiver 15 (handheld or dash-mounted) and vehicle 11 carries two-way transceiver 16. When in range communication channels are available between transceivers 15 and 16, allowing the vehicle occupants to engage in wireless conversation.

To make access to a nearby vehicle via wireless P2P communication more readily available when needed, the invention utilizes regular monitoring of a wireless environment around a vehicle as it operates to track a caravan or group of vehicles each of which is close enough to maintain P2P links.

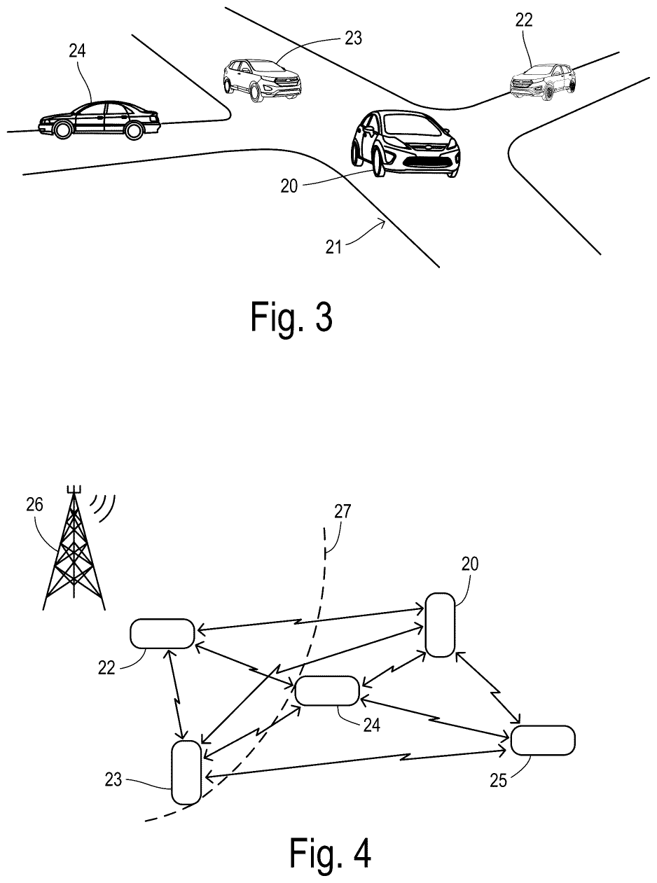

FIG. 3 shows a host vehicle 20 operating on a roadway system 21. Nearby vehicles 22, 23, and 24 operate compatible P2P transceivers within a receivable range of vehicle 20 and can be considered to form a moving caravan of vehicles. A caravan can be any group of vehicles all within range of one another, wherein the group may evolve over time with vehicles joining or leaving the group. FIG. 4 shows another representation of the group wherein host vehicle 20 operates a wireless P2P transceiver exchanging two-way messages with compatible transceivers in remote vehicles 22, 23, 24, and 25. In addition, vehicles 20 and 22-25 have telematics units for intercommunicating with a mobile telephone system via a cellular base station 26. Each telematics unit may be comprised of (1) a handheld mobile cellular phone of an occupant wirelessly coupled to the fixed electronics of a vehicle (e.g., via Bluetooth®) or (2) a cellular transceiver fixed to a respective vehicle.

A caravan grouping of vehicles including vehicles 20 and 22-25 may include vehicles in direct two-way communication or vehicles in in-direct communication by exchanging two-way messages through another member vehicle of the group (e.g., exchange of messages between vehicles 20 and 23 via intermediate vehicle 24). The caravan grouping covers a geographic region whereby some vehicles may be within a communication range of cellular base station 26 while others are not. For example, a maximum reception range 27 may exist for base station 26, such that host vehicle 20 is not within range of the cellular communication while vehicle 22 has cellular coverage. Since there is an existing P2P link between vehicles 20 and 22, an emergency call from vehicle 20 can be relayed to a PSAP by vehicle 22 on behalf of vehicle 20.

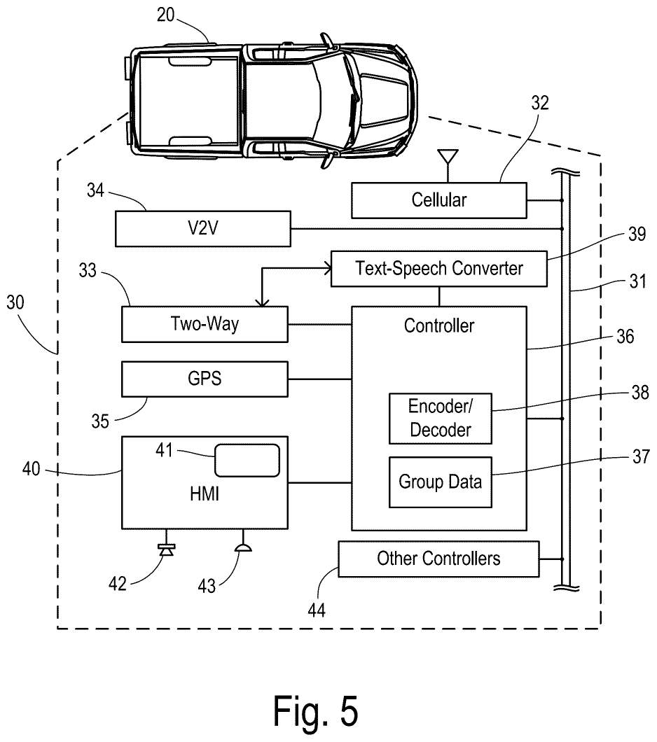

FIG. 5 shows a system of components 30 within vehicle 20 that may be used in an embodiment of the invention. Onboard systems are generally interconnected by a serial communication bus 31. Wireless transceivers in vehicle 20 may include a cellular transceiver 32, two-way P2P transceiver 33, and V2V transceiver 34. Cellular transceiver 32 may be comprised of a telematics unit with a cellular modem/controller capable of operation with or without user intervention or may be comprised of a handheld cellular telephone with a local network connection (e.g., Bluetooth®) to a network node in vehicle 20. A GPS receiver 35 is provided for obtaining geographic coordinates for vehicle 20 (e.g., in connection with navigation functions or for use in automatic distress messages).

A controller 36 is configured to exchange data and commands with transceivers 32-34, receiver 35, a text-speech converter 39, a human-machine interface (HMI) 40, and other electronic control modules 44 either directly or via bus 31. Controller 36 is configured to manage a group of vehicles in P2P communication, distribute and collect vehicle data of the host vehicle and remote vehicles in the group, detect emergency call triggers, and coordinate relaying of emergency messages as needed when a vehicle without cellular availability wants to initiate an emergency call. Thus, controller 36 maintains a group database 37 during normal vehicle usage (i.e., before an emergency trigger occurs). When exchanging voice or data messages with other vehicles, controller 36 may utilize a data/voice encoder/decoder 38 and/or text-speech converter 39 as needed for the available communication channels with each other vehicle in a group.

The other electronic modules 44 may include vehicle safety systems with a vehicle controller which can automatically detect a trigger condition such as a crash, thereby functioning as an emergency call activator to automatically initiate relaying of an emergency call with a two-way P2P link to another vehicle. Electronic modules 44 can also include a powertrain controller or vehicle body controller which provide data relating to vehicle statuses or malfunctions to be reported in connection with an emergency call.

HMI 40 provides a user interface to collect user input and to share user output. For example, HMI 40 may comprise a touchscreen display panel 41, a loudspeaker 42, and a microphone 43. HMI 40 may include an audio processor coupled to loudspeaker 42 and microphone 43. In some embodiments, loudspeaker 42 and microphone 43 may be used in exchanging voice audio signals passing through transceivers 32 and/or 33 (either during or prior to an emergency call). In some embodiments, display panel 41 may display text output from text-speech converter 39. Using the touchscreen function of panel 41 or using speech commands or other inputs, a user can manually initiate an emergency call (which may need to be relayed via another vehicle when a cellular service is not available). As used herein, emergency call may include any type of request for assistance prompted by any event such as running out of fuel, etc.

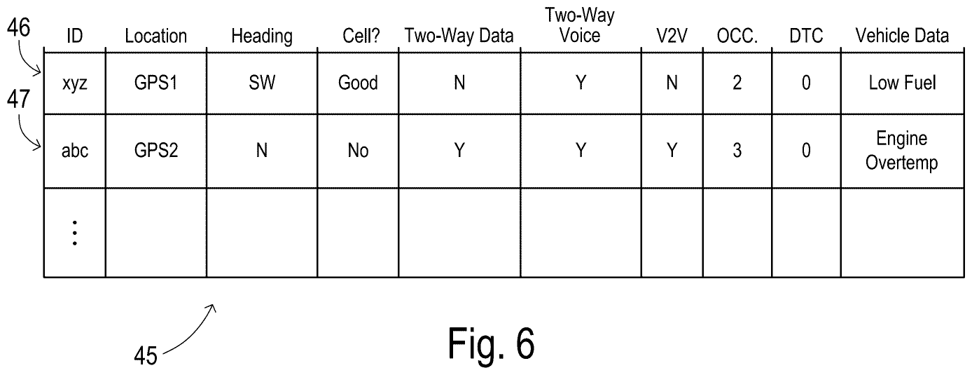

Based on polling messages and various other messages for updating vehicle statuses within a group, group database 37 may compile dynamic records associated with respective vehicles in the group. FIG. 6 shows a portion of a memory array 45 with records 46 and 47 corresponding to two respective vehicles in a group. Each vehicle may be assigned a vehicle ID (either a predefined unique code or determined on-the-fly). Each record may store a respective vehicle location (e.g., GPS coordinates) and a vehicle heading to assist in identifying vehicles best tracking the general movement of the host vehicle so that a robust grouping of vehicles in a caravan can be determined. Additional data includes wireless status and/or capability of each remote vehicle in the group, such as whether each vehicle has cellular connectivity (i.e., whether or not it could complete an emergency call to a PSAP), strength of the cellular signal, whether or not the remote two-way P2P transceiver has capability to send/receive voice signals or data signals, and whether there is V2V communication availability. In some embodiments, other vehicle data useful in handling emergencies can also be compiled in the data records, such as number of occupants, distress or other condition of occupants, malfunction codes (e.g., diagnostic trouble codes or DTCs), or specifically enumerated issues (e.g., low fuel or engine overheating).

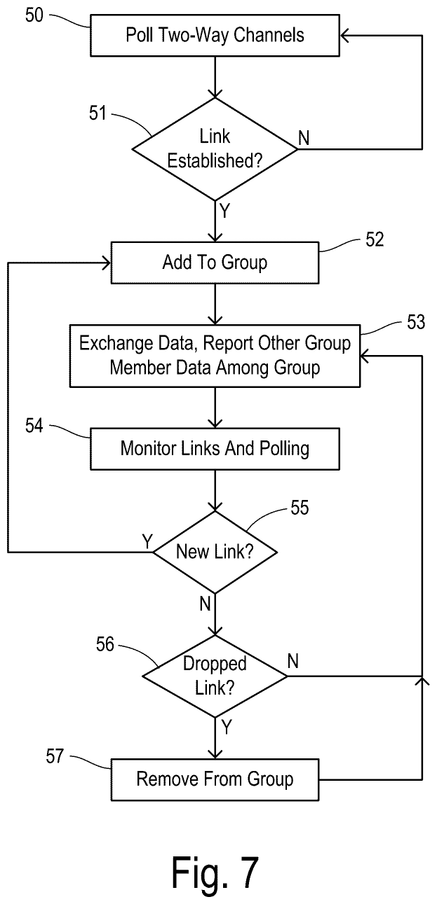

FIG. 7 shows one embodiment of a method of the invention wherein a vehicle having a two-way P2P transceiver polls predetermined two-way communication channels in step 50. Polling may occur during normal vehicle operation in order to find nearby vehicles for inclusion in a caravan grouping. A check is performed in step 51 to determine whether any remote two-way link is established. If not, then polling continues in step 50. When a link is established, the corresponding vehicle may be added to the group in step 52. In step 53, two-way P2P messages are exchanged between the two vehicles in order to share relevant data (e.g., cellular availability) and to report other group member data within the group. On an ongoing basis, the host vehicle continues to monitor existing links and performs polling in step 54. A check is performed in step 55 to determine whether there is a new link. If so, then a new vehicle and its data are added to the group in step 52. Otherwise, a check is performed in step 56 to determine whether any link has been dropped. If not, then a return is made to step 53 to continue exchanging messages. If a link is dropped, then it is removed from the group in step 57 before returning to step 53.

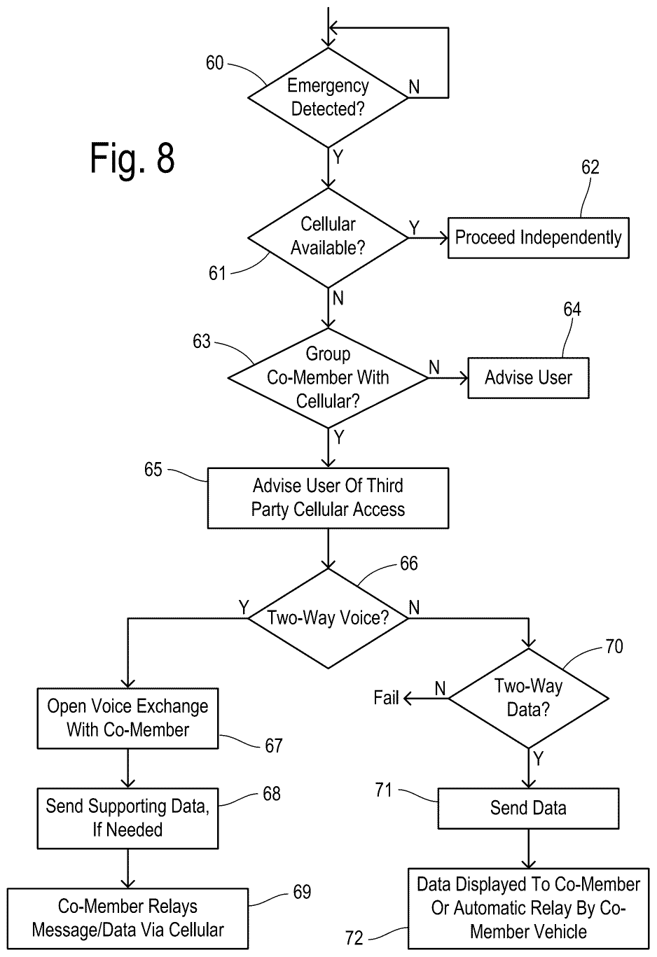

FIG. 8 shows an embodiment of a method which monitors for emergency conditions and reacts appropriately. In step 60, a check is performed to determine whether an emergency is detected. Detection of an emergency may be done automatically by the vehicle or may result from manual actions by a user (e.g., pressing a corresponding control button or a spoken command). When an emergency condition is detected, then a check is performed in step 61 to determine whether cellular service is available. If it is available, then the vehicle and/or occupants proceed independently in step 62 since the corresponding emergency call can be handled within the host vehicle.

If cellular service is not available, then a check is performed in step 63 to determine whether there is a current group co-member with cellular availability. If not, then the user may be advised in step 64 by an appropriate message or other signal via a vehicle HMI or the occupants handheld cell phone. When there is a group co-member with cellular availability, then the user may be advised of the possibility of relaying an emergency call using a third-party's cellular access in step 65. A check is performed in step 66 to determine whether there is an existing two-way voice channel with the remote vehicle which is selected to be an intermediary. If so, then voice exchange is opened with that group co-member in step 67. This allows the occupants of the two vehicles to converse over a two-way voice channel to arrange for an emergency response or other actions. In step 68, supporting data can be sent either in machine-readable or human-readable form if needed. In step 69, the remote co-member may relay the messages or data via the cellular connection on behalf of the vehicle initiating an emergency call.

When a two-way voice channel is not found in step 66, then a check is performed in step 70 to determine whether the two-way P2P connection supports data messages. If not, then the process fails and a user may be appropriately informed. If two-way data is available, then the data is sent in step 71 and may be displayed in step 72 to the co-member on a display screen in the remote vehicle. Alternatively, the data can be automatically relayed by the co-member's vehicle to the PSAP or other potential responder.

In the foregoing method, a host vehicle having an available connection to a mobile telephone system may detect a request from one of the remote vehicles in its group for contacting the PSAP on behalf of that remote vehicles. Subsequently, the host vehicle receives remote messages from the one of the remote vehicles via the wireless P2P transceiver, and then forwards voice or data content obtained from the remote messages to the PSAP. In some embodiments, a user interface in the host vehicle displays the voice or data content to enable a user within the vehicle to repeat the voice or data content to the PSAP. Alternatively, the vehicles may be configured to handle the message forwarding automatically without user involvement.

What is claimed is:

1. A vehicle comprising:
a wireless peer-to-peer (P2P) transceiver adapted to exchange two-way messages with remote transceivers in remote vehicles;
a telematics unit adapted to intercommunicate with a mobile telephone system;
an emergency call activator triggered in the vehicle according to predetermined emergency conditions in the vehicle; and
a logic controller coupled to the wireless P2P transceiver and configured for (1) exchanging polling messages with the remote vehicles, and (2) compiling a group list of specific remote vehicles which remain contactable via the wireless P2P transceiver together with a respective status of a connection of each remote vehicle to the mobile telephone system;
wherein when the emergency call activator is triggered and the telematics unit is unable to intercommunicate with the mobile telephone system, then the logic controller selects a remote vehicle and initiates a messaging sequence via the wireless P2P transceiver for requesting assistance via the selected remote vehicle.

2. The vehicle of claim 1 wherein the logic controller selects the remote vehicle from the group list having a respective connection to the mobile telephone system and to a public safety answering point (PSAP) via the mobile telephone system, and wherein the messaging sequence via the wireless P2P transceiver operates to relay an emergency call to the PSAP via the selected remote vehicle.

3. The vehicle of claim 2 wherein the messaging sequence is comprised of voice messages.

4. The vehicle of claim 2 wherein the messaging sequence is comprised of data messages.

5. The vehicle of claim 4 wherein the data messages identify a vehicle location, a vehicle malfunction, or a distress of an occupant.

6. The vehicle of claim 2 wherein the logic controller is further configured for (3) detecting a request from one of the remote vehicles for contacting the PSAP on behalf of the one of the remote vehicles, (4) receiving remote messages from the one of the remote vehicles via the wireless P2P transceiver, and (5) forwarding voice or data content within the remote messages to the PSAP.

7. The vehicle of claim 6 further comprising:
a user interface configured to display the voice or data content for forwarding to enable a user within the vehicle to repeat the voice or data content to the PSAP.

8. The vehicle of claim 2 wherein the emergency call activator comprises a user interface configured to receive a manual trigger from a user in the vehicle.

9. The vehicle of claim 2 wherein the emergency call activator comprises a vehicle controller automatically detecting a trigger condition including a crash.

10. A method of communication between a vehicle and a public safety answering point (PSAP), wherein the vehicle has a wireless peer-to-peer (P2P) transceiver adapted to exchange two-way messages with remote transceivers in remote vehicles, a telematics unit adapted to intercommunicate with a mobile telephone system, and an emergency call activator triggered in the vehicle according to predetermined emergency conditions in the vehicle, the method comprising the steps of:
exchanging polling messages with the remote vehicles via the wireless P2P transceiver;
compiling a group list of specific remote vehicles which remain contactable via the wireless P2P transceiver together with a respective status of a connection of each remote vehicle to the mobile telephone system;
when the emergency call activator is triggered and the telematics unit is unable to intercommunicate with the mobile telephone system, then selecting a remote vehicle from the group list which has a respective connection to the mobile telephone system; and
initiating a messaging sequence via the wireless P2P transceiver for relaying an emergency call to the PSAP via the selected remote vehicle.

11. The method of claim 10 wherein the messaging sequence is comprised of voice messages.

12. The method of claim 10 wherein the messaging sequence is comprised of data messages.

13. The method of claim 12 wherein the data messages identify a vehicle location, a vehicle malfunction, or a distress of an occupant.

14. The method of claim 10 further comprising the steps of:
detecting a request from one of the remote vehicles for contacting the PSAP on behalf of the one of the remote vehicles;
receiving remote messages from the one of the remote vehicles via the wireless P2P transceiver; and
forwarding voice or data content within the remote messages to the PSAP.

15. The method of claim 14 further comprising the step of:
displaying the voice or data content to be forwarded to a user within the vehicle on a user interface to enable the user to repeat the voice or data content to the PSAP.

16. The method of claim 10 wherein the emergency call activator comprises a user interface configured to receive a manual trigger from a user in the vehicle.

17. The method of claim 10 wherein the emergency call activator comprises a vehicle controller automatically detecting a trigger condition including a crash.
